(19) United States
(12) Patent Application Publication
(10) Pub. No.: US 2024/0013031 A1
(43) Pub. Date: Jan. 11, 2024

(54) METHOD AND APPARATUS FOR ARTIFICIAL NEURAL NETWORK BASED FEEDBACK

(71) Applicant: Electronics and Telecommunications Research Institute, Daejeon (KR)

(72) Inventors: Han Jun PARK, Daejeon (KR); Yong Jin KWON, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: Electronics and Telecommunications Research Institute, Daejeon (KR)

(21) Appl. No.: 18/349,005

(22) Filed: Jul. 7, 2023

(30) Foreign Application Priority Data
Jul. 8, 2022 (KR) 10-2022-0084070
Jul. 25, 2022 (KR) 10-2022-0092035
Jun. 14, 2023 (KR) 10-2023-0076074

(51) Int. Cl. G06N 3/0455

(52) U.S. Cl. CPC G06N 3/0455

(57) ABSTRACT

An operation method of a first communication node may comprise: determining a latent space correction operation including a transformation operation for correcting latent data output from a first encoder of a first artificial neural network corresponding to the first communication node, based on information of a reference data set provided from a second communication node; encoding first input data including first feedback information through the first encoder; correcting first latent data output from the first encoder based on the determined latent space correction operation; and transmitting a first feedback signal including the corrected first latent data to the second communication node, wherein the corrected first latent data is decoded into first output data corresponding to the first input data in a second decoder of a second artificial neural network corresponding to the second communication node.

### CROSS-REFERENCE TO RELATED APPLICATIONS

This application claims priority to Korean Patent Applications No. 10-2022-0084070, filed on Jul. 8, 2022, No. 10-2022-0092035, filed on Jul. 25, 2022, and No. 10-2023-0076074, filed on Jun. 14, 2023, with the Korean Intellectual Property Office (KIPO), the entire contents of which are hereby incorporated by reference.

### BACKGROUND

### 1. Technical Field

Exemplary embodiments of the present disclosure relate to an artificial neural network-based feedback technique in a communication system, and more specifically, to a technique for a transmitting node and a receiving node to transmit and receive feedback information such as channel state information based on artificial neural networks.

### 2. Related Art

With the development of information and communication technology, various wireless communication technologies are being developed. Representative wireless communication technologies include long-term evolution (LTE) and new radio (NR) defined as the 3rd generation partnership project (3GPP) standards. The LTE may be one of the 4th generation (4G) wireless communication technologies, and the NR may be one of the 5th generation (5G) wireless communication technologies.

For the processing of rapidly increasing wireless data after commercialization of the 4G communication system (e.g., communication system supporting LTE), the 5G communication system (e.g., communication system supporting NR) using a frequency band (e.g., frequency band above 6 GHz) higher than a frequency band (e.g., frequency band below 6 GHz) of the 4G communication system as well as the frequency band of the 4G communication system is being considered. The 5G communication system can support enhanced Mobile BroadBand (eMBB), Ultra-Reliable and Low-Latency Communication (URLLC), and massive machine type communication (mMTC) scenarios.

Recently, research on the application of artificial intelligence (AI) and machine learning (ML) technologies to mobile communication is actively underway. For example, methods for improving the performance of a feedback procedure such as channel state information (CSI) feedback based on AUML are being studied. However, artificial neural network structures (or algorithms, etc.) according to AUML technologies are judged as unique assets of terminal providers or service providers, and may not be widely disclosed. As such, in order to perform artificial neural network-based feedback operations even in a situation where information on the structure of the artificial neural network itself is not accurately shared between communication nodes, a technique for ensuring compatibility between artificial neural networks may be required.

Matters described as the prior arts are prepared to promote understanding of the background of the present disclosure, and may include matters that are not already known to those of ordinary skill in the technology domain to which exemplary embodiments of the present disclosure belong.

### SUMMARY

Exemplary embodiments of the present disclosure are directed to providing an artificial neural network-based method and apparatus capable of improving performance of a feedback procedure by ensuring compatibility between artificial neural networks.

According to a first exemplary embodiment of the present disclosure, an operation method of a first communication node may comprise: determining a latent space correction operation including a transformation operation for correcting latent data output from a first encoder of a first artificial neural network corresponding to the first communication node, based on information of a reference data set provided from a second communication node; encoding first input data including first feedback information through the first encoder; correcting first latent data output from the first encoder based on the determined latent space correction operation; and transmitting a first feedback signal including the corrected first latent data to the second communication node, wherein the corrected first latent data is decoded into first output data corresponding to the first input data in a second decoder of a second artificial neural network corresponding to the second communication node.

The operation method may further comprise, before the determining of the latent space correction operation, performing first learning so that at least the first encoder has isometric transformation characteristics, wherein the isometric transformation characteristics mean that a distance between two arbitrary input values input to the first encoder and a distance between two output values corresponding to the two input values and output from the first encoder have a k-fold relationship, k being a positive real value.

The operation method may further comprise, before the determining of the latent space correction operation, transmitting, to the second communication node, a first capability report indicating that the first communication node does not support a learning operation for isometric transformation characteristics of the first artificial neural network; and transmitting, to the second communication node, information of a first codebook corresponding to the first artificial neural network and first identification information, wherein the first identification information includes at least one of identification information of the first artificial neural network or identification information of the first codebook.

The operation method may further comprise, before the determining of the latent space correction operation, transmitting, to the second communication node, a first capability report indicating that the first communication node does not support a learning operation for isometric transformation characteristics of the first artificial neural network; receiving, from the second communication node, second identification information of a codebook corresponding to a third artificial neural network of a third communication node; comparing the second identification information with first identification information; and when the first and second identification information overlap, determining that the second communication node has previously acquired information of a first codebook corresponding to the first artificial neural network through the third communication node.

The operation method may further comprise, before the determining of the latent space correction operation, performing second learning for the first artificial neural network, wherein the second learning is performed based on a total loss function determined by a combination of one or more loss functions of a first loss function, a second loss function, or a third loss function, and wherein the first loss function is defined based on a relationship between a second encoder of the second artificial neural network of the second communication node and the first encoder, the second loss function is defined based on input values and output values of the first decoder of the first artificial neural network, and the third loss function is defined based on input values and output values of the first encoder.

The first loss function may be defined based on a size of an error between a first latent data set that is a result of encoding the reference data set through the first encoder and a second latent data set that is a result of encoding the reference data set through the second encoder.

The operation method may further comprise, before the performing of the second learning, receiving, from the second communication node, information on a first coefficient corresponding to the first loss function, a second coefficient corresponding to the second loss function, and a third coefficient corresponding to the third loss function; and determining the total loss function based on the first to third coefficients, wherein the first to third coefficients are real numbers of 0 or more, respectively.

The transformation operation included in the latent space correction operation may be determined to include at least one of a transition transformation operation, a rotation transformation operation, or a scaling transformation operation for the latent data output from the first encoder within a first latent space corresponding to an output end of the first encoder.

The determining of the latent space correction operation may comprise: receiving, from the second communication node, information of a second latent data set generated based on the reference data set in a second encoder of the second artificial neural network included in the second communication node; generating a first latent data set located in a first latent space corresponding to an output end of the first encoder by encoding the reference data set through the first encoder; and determining the transformation operation included in the latent space correction operation such that a distance between the first and second latent data sets is minimized when the first latent data set is corrected based on the latent space correction operation.

The determining of the transformation operation may comprise: identifying positions of one or more data elements constituting the first latent data set in the first latent space (hereinafter, first latent data element positions); calculating an average of the first latent data element positions and identifying a centroid of the first latent data element positions; and determining a first transition transformation operation for making the identified centroid an origin of the first latent space, wherein the second latent data set is corrected by the second communication node based on a second transition transformation operation based on an origin of a second latent space corresponding to an output end of the second encoder.

The first and second latent data sets may correspond to first and second matrixes each composed of one or more column vectors respectively corresponding to one or more data elements, and the determining of the transformation operation may comprise: identifying a first transformation matrix such that a distance between a third matrix generated by multiplying the first transformation matrix by the first matrix and the second matrix is minimized; and determining the transformation operation corresponding to the first transformation matrix.

According to a second exemplary embodiment of the present disclosure, an operation method of a first communication node may comprise: transmitting, to a second communication node, information related to a reference data set required for determining a latent space correction operation including a transformation operation for correcting latent data output from a second encoder of a second artificial neural network corresponding to the second communication node; receiving a first feedback signal from the second communication node; obtaining first latent data included in the first feedback signal; performing a decoding operation on the first latent data based on a first decoder of a first artificial neural network corresponding to the first communication node; and obtaining first feedback information based on first output data output from the first decoder, wherein the first latent data included in the first feedback signal corresponds to a result obtained by correcting second latent data output from the second encoder based on the latent space correction operation, and the second latent data is generated by encoding first input data including second feedback information corresponding to the first feedback information through the second encoder.

The operation method may further comprise, before the receiving of the first feedback signal, receiving, from the second communication node, a first capability report indicating that the second communication node does not support a learning operation for isometric transformation characteristics of the second artificial neural network; and receiving, from the second communication node, information of a first codebook corresponding to the second artificial neural network and first identification information, wherein the first identification information includes at least one of identification information of the second artificial neural network or identification information of the first codebook.

The operation method may further comprise, before the receiving of the first feedback signal, receiving, from a third communication node, information of a second codebook corresponding to a third artificial neural network corresponding to the third communication node and second identification information; receiving, from the second communication node, a first capability report indicating that the second communication node does not support a learning operation for isometric transformation characteristics of the second artificial neural network; and transmitting the second identification information to the second communication node.

The operation method may further comprise, before the receiving of the first feedback signal, transmitting, to the second communication node, a first signaling for second learning for the second artificial neural network of the second communication node, wherein the second learning is performed based on a total loss function determined by a combination of one or more loss functions of a first loss function, a second loss function, or a third loss function, and wherein the first loss function is defined based on a relationship between a first encoder of the first artificial neural network of the first communication node and the second encoder, the second loss function is defined based on input values and output values of the second decoder of the second artificial neural network, and the third loss function is defined based on input values and output values of the second encoder.

The first loss function may be defined based on a size of an error between a first latent data set that is a result of encoding the reference data set through the first encoder and a second latent data set that is a result of encoding the reference data set through the second encoder.

The first signaling may include information on a ratio of a first coefficient corresponding to the first loss function, a second coefficient corresponding to the second loss function, and a third coefficient corresponding to the third loss function, the total loss function may be determined based on the first to third coefficients, and the first to third coefficients may be real numbers of 0 or more, respectively.

The transformation operation included in the latent space correction operation may be determined to include at least one of a transition transformation operation, a rotation transformation operation, or a scaling transformation operation for the latent data output from the second encoder within a second latent space corresponding to an output end of the second encoder.

The transmitting of the information related to the reference data set may comprise: configuring information related to a first latent data set generated by encoding the reference data set through a first encoder of the first artificial neural network; and transmitting, to the second communication node, information of the reference data set and the information related to the first latent data set, wherein the latent space correction operation is determined based on a relationship between a second latent data set generated by encoding the reference data set through the second encoder and the first latent data set.

The configuring of the information related to the first latent data set may comprise: identifying positions of one or more data elements constituting the first latent data set (hereinafter, first latent data element positions) on a first latent space corresponding to an output end of a first encoder of the first artificial neural network; calculating an average of the first latent data element positions and identifying a centroid of the first latent data element positions; correcting the first latent data set so that the identified centroid becomes an origin of the first latent space; and configuring the information related to the first latent data set to include information on the corrected first latent data set.

According to an exemplary embodiment of an artificial neural network-based feedback method and apparatus in a communication system, communication nodes (e.g., base station and terminal) in the communication system may include artificial neural networks for a feedback procedure (e.g., CSI feedback procedure). In a transmitting node that transmits feedback information, a compressed form of the feedback information may be generated through an encoder of an artificial neural network. A receiving node that receives the feedback information may receive the compressed form of the feedback information from the transmitting node. The receiving node may restore the original feedback information from the compressed form of the feedback information through a decoder of an artificial neural network. For such the feedback procedure, operations for ensuring compatibility based on isometric transformation characteristics of the artificial neural networks may be performed. Through this, the performance of the artificial neural network-based feedback operation can be improved.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram for describing an exemplary embodiment of an artificial neural network-based feedback technique in a communication system.

FIGS. 4A to 4C are conceptual diagrams for describing a first exemplary embodiment of an artificial neural network structure for a feedback procedure.

FIG. 5 is a conceptual diagram for describing first to third exemplary embodiments of an artificial neural network-based feedback method.

FIG. 6 is a conceptual diagram for describing a fourth exemplary embodiment of an artificial neural network-based feedback method.

FIG. 7 is a conceptual diagram for describing fifth and sixth exemplary embodiments of an artificial neural network-based feedback method.

FIG. 8 is a conceptual diagram for describing seventh and eighth exemplary embodiments of an artificial neural network-based feedback method.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

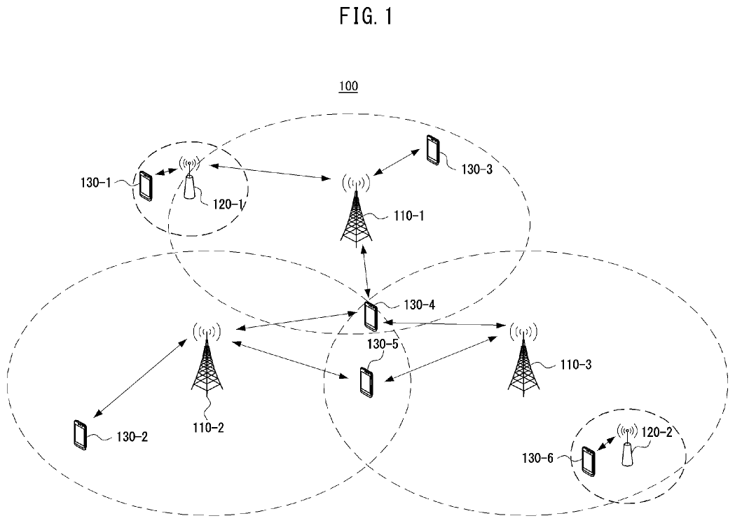

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

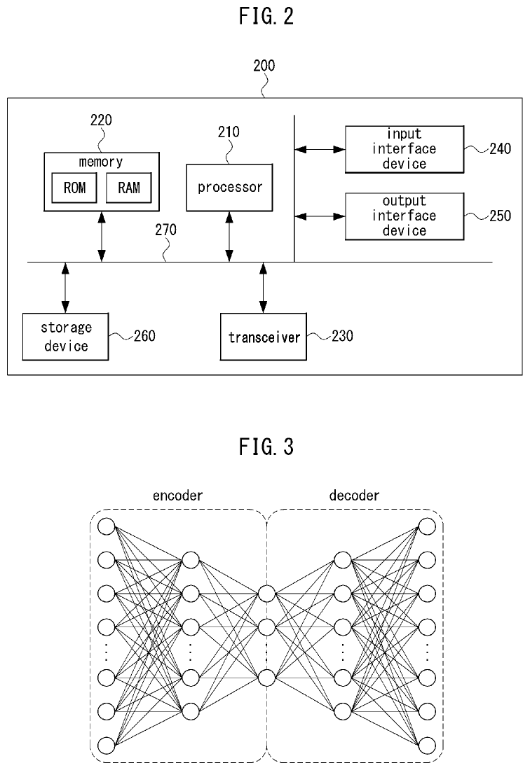

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, artificial neural network based channel state information transmission and reception methods in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a receiving node is described, a corresponding transmitting node may perform an operation corresponding to the operation of the receiving node. Conversely, when an operation of a transmitting node is described, a corresponding receiving node may perform an operation corresponding to the operation of the transmitting node.

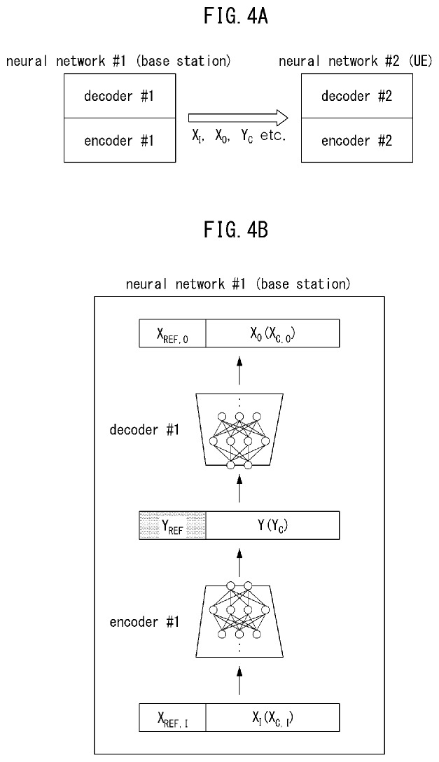

FIG. 3 is a conceptual diagram for describing an exemplary embodiment of an artificial neural network-based feedback technique in a communication system.

Recently, research on the application of artificial intelligence (AI) and machine learning (ML) technologies to mobile communication is actively underway. For example, methods for improving the performance of a feedback procedure such as channel state information (CSI) feedback based on AI/ML are being studied. However, artificial neural network structures (or algorithms, etc.) according to AI/ML technologies are judged as unique assets of terminal providers or service providers, and may not be widely disclosed. As such, a technique for improving the performance of artificial neural network-based feedback transmission/reception operations even in a situation where information on the structure of the artificial neural network itself is not accurately shared between communication nodes may be required.

Specifically, in order for a base station to apply a transmission technique such as multiple input multiple output (MIMO) or precoding in a communication system, the base station may need to acquire radio channel information between the base station and a terminal. In order for the base station to acquire radio channel information, the following schemes may be used.
When the base station transmits a reference signal, the terminal may receive the reference signal transmitted from the base station. The terminal may measure CSI using the reference signal received from the base station. The terminal may report the measured CSI to the base station. This scheme may be referred to as ‘CSI feedback’ or ‘CSI reporting’.
When the terminal transmits a reference signal, the base station may receive the reference signal transmitted from the terminal. The base station may directly measure an uplink channel using the reference signal received from the terminal, and may assume or estimate a downlink channel based on the measured uplink channel. This scheme may be referred to as ‘channel sounding’.

An exemplary embodiment of the communication system may support one or both of the two channel information acquisition schemes. For example, in relation to the CSI feedback scheme, feedback information such as a channel quality indicator (CQI), precoding matrix indicator (PMI), and rank indicator (RI) may be supported. Meanwhile, in relation to the channel sounding scheme, a sounding reference signal (SRS), which is a reference signal for estimating an uplink channel, may be supported.

Specifically, the CQI may be information corresponding to a downlink signal to interference and noise power ratio (SINR). The CQI may be expressed as information on a modulation and coding scheme (MCS) that meets a specific target block error rate (BLER). The PMI may be information on a precoding selected by the terminal. The PMI may be expressed based on a pre-agreed codebook between the base station and the terminal. The RI may mean the maximum number of layers of a MIMO channel.

Which scheme among the CSI feedback scheme and the channel sounding scheme is more effective for acquiring channel information at the base station and performing communication with the terminal according to the channel information may be determined differently according to a communication condition or communication system. For example, in a system in which reciprocity between a downlink channel and an uplink channel is guaranteed or expected (e.g., time division duplex (TDD) system), it may be determined that the channel sounding scheme in which the base station directly acquires channel information is relatively advantageous. However, the uplink reference signals used for the channel sounding scheme may have a high transmission load, and thus may not be easily applied to all terminals within the network.

Even in the CSI feedback scheme, a technique enabling sophisticated channel representation may be required. In an exemplary embodiment of the communication system, two types of codebooks may be supported to convey the PMI information. For example, a Type 1 codebook and a Type 2 codebook may be supported to convey the PMI information. Here, the Type 1 codebook may represent a beam group with oversampled discrete Fourier transform (DFT) matrixes, and one beam selected from among them (or information on the selected one beam) may be reported. On the other hand, according to the Type 2 codebook, a plurality of beams may be selected, and information composed of a linear combination of the selected beams may be reported. The Type 2 codebook may be easier to support a transmission technique such as multi-user MIMO (MU-MIMO) compared to the Type 1 codebook. However, in the case of the Type 2 codebook, a codebook structure thereof is relatively complex, and thus the load of the CSI feedback procedure may greatly increase.

A technique for reducing the load of transmission and reception operations of feedback information such as CSI may be required. For example, a method of combining technologies such as AI and ML to a transmission and reception procedure (i.e., feedback procedure) of feedback information such as CSI may be considered.

Recently, AI and ML technologies have made remarkable achievements in the field of image and natural language. Thanks to the development of AI/ML technologies, research in academia and industry is actively being conducted to apply AI/ML technologies to mobile communication systems. For example, the 3rd generation partnership project (3GPP), an international standardization organization, is conducting researches to apply AI/ML technologies to air interfaces of mobile communication systems. In such the researches, the 3GPP are considering the following three use cases as representative use cases.

(1) AWL-based CSI feedback

(2) AI/ML based beam management

(3) AI/ML based positioning

In these AWL-based CSI feedback use cases, the 3GPP is discussing a CSI compression scheme for compressing channel information based on AI/ML and a CSI prediction scheme for predicting channel information at a future time point based on AUML. In addition, in the AI/ML-based beam management use case, the 3GPP is discussing a beam prediction scheme for predicting beam information in the time/space domain based on AUML. In addition, in the AWL-based positioning use case, the 3GPP is discussing a method of directly estimating a position of a terminal based on AI/ML and a method of assisting conventional positioning techniques based on AUML.

Meanwhile, the academic world may be conducting researches in the direction of applying AI/ML techniques to all areas of mobile communications, including the above-described representative use cases. Specifically, in relation to the AWL-based CSI feedback use case, academia may be proposing a CSI compression scheme that compresses channel information by utilizing a convolutional neural network (CNN)-based autoencoder, one of AI/ML technologies. This auto-encoder technique may refer to a neural network structure that copies inputs to outputs. In such the auto-encoder, the number of neurons of a hidden layer between an encoder and a decoder may be set to be smaller than that of an input layer to compress (or reduce dimensionality) data. In this AWL-based CSI compression technique, an artificial neural network may be trained to correspond channel state information to latent variables (or codes) on a latent space by compressing channel information into the channel state information. However, in such the AI/ML-based CSI compression technique, the channel state information compressed into the latent space cannot be described and controlled.

In an exemplary embodiment of the communication system, the following AI/ML models may be considered.

1. One-sided AI/ML Model

1-A. AI/ML model in which inference is performed entirely in the terminal or network (e.g., UE-sided AI/ML model, Network-sided AI/ML model, etc.)

2. Two-sided AI/ML Model

2-A. Paired AI/ML model(s) in which joint inference is performed

2-B. Here, ‘joint inference’ includes an AI/ML inference in which inference is jointly performed across the terminal and the network.

2-C. For example, a first part of the inference may be performed by the terminal and the remaining part may be performed by the base station.

2-C. On the other hand, the first part of the inference may be performed by the base station and the remaining part may be performed by the terminal.

According to the above-described classification of AI/ML model types, the auto-encoder-based CSI feedback scheme may correspond to the two-sided AI/ML model. Specifically, the terminal may generate a CSI feedback by utilizing an artificial neural network-based encoder of the terminal. The base station may interpret the CSI feedback generated by the terminal by using an artificial neural network-based decoder of the base station. Since the two-sided AI/ML model defines one AI/ML algorithm by using a pair of AWL models, it may be preferable to train the pair of AWL models together.

However, the artificial neural network structure (or algorithm, etc.) according to the AI/ML technologies are judged as a unique asset of the terminal provider or service provider, and may not be widely disclosed. Accordingly, without a process of directly exchanging AI/ML model information between different network nodes or performing joint training on the pair of AI/ML models within the two-sided AI/ML model, artificial neural networks for CSI feedback may be individually configured. Even when different network nodes individually configure artificial neural networks for CSI feedback in the above-described manner, a technique for ensuring compatibility may be required for correct interpretation of feedback information. For example, a scheme in which the terminal and the base station individually configure artificial neural network-based encoder and decoder, but perform training of the encoder and/or decoder so that the decoder can accurately interpret an encoding result of the encoder may be applied.

Hereinafter, for convenience of description, an artificial neural network learning and configuration method proposed in the present disclosure will be mainly described in terms of a downlink of a wireless mobile communication system composed of a base station and a terminal. However, proposed methods of the present disclosure may be extended and applied to any wireless mobile communication system composed of a transmitter and a receiver. Hereinafter, channel state information may be an arbitrary compressed form of channel information.

Referring to FIG. 3, in an exemplary embodiment of an artificial neural network based feedback technique, a base station and/or a terminal may each include a channel state information feedback apparatus. The channel state information feedback apparatus may include an encoder and/or a decoder. In this case, the encoder and decoder may form an auto-encoder. The encoder may be located at least at the terminal, and the decoder may be located at least at the base station. Such the auto-encoder may perform data compression (or dimensionality reduction) by setting the number of neurons at a hidden layer between the encoder and the decoder to be smaller than that of an input layer. Such the autoencoder may be configured based on a convolutional neural network (CNN). Here, the encoder may be referred to as a channel compression artificial neural network.

The configurations described with reference to FIG. 3 are merely examples for convenience of description, and exemplary embodiments of the artificial neural network-based feedback technique are not limited thereto. The configurations described with reference to FIG. 3 may be equally or similarly applied even in a situation where the base station is replaced by the terminal and the terminal is replaced by the base station. For example, at least part of the configurations described with reference to FIG. 3 may be applied identically or similarly to a situation in which the base station transmits feedback information to the terminal. Alternatively, the configurations described with reference to FIG. 3 may be applied identically or similarly to a situation in which the base station and the terminal are replaced by a first communication node and a second communication node, respectively. For example, at least part of the configurations described with reference to FIG. 3 may be applied identically or similarly to a situation in which a first communication node and a second communication node transmit and receive feedback information in uplink communication, downlink communication, sidelink communication, unicast-based communication, multicast-based communication, broadcast-based communication, and/or the like.

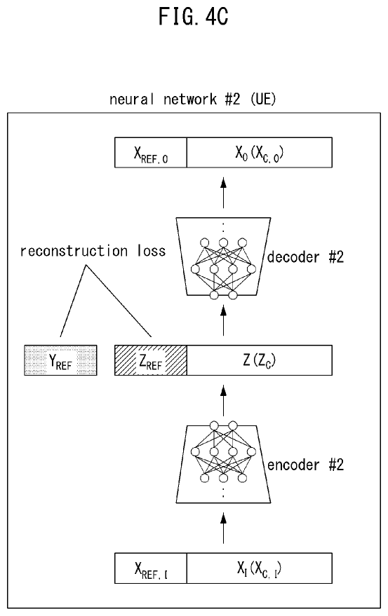

FIGS. 4A to 4C are conceptual diagrams for describing a first exemplary embodiment of an artificial neural network structure for a feedback procedure.

Referring to FIGS. 4A to 4C, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback operation between the base station and the terminal may be performed based on one or more artificial neural networks configured for the feedback procedure. Hereinafter, in describing the first exemplary embodiment of the artificial neural network structure for the feedback procedure (hereinafter referred to as ‘first exemplary embodiment of artificial neural network structure’) with reference to FIGS. 4A to 4C, descriptions overlapping with those described with reference to FIGS. 1 to 3 may be omitted.

[First Exemplary Embodiment of Artificial Neural Network Structure]

Referring to FIG. 4A, in the first exemplary embodiment of the artificial neural network structure, the base station and the terminal may each include an artificial neural network (hereinafter referred to as ‘neural network’) configured for the feedback procedure (e.g., CSI feedback procedure). The base station may include a neural network #1, and the terminal may include a neural network #2. The neural network #1 and the neural network #2 may each have an auto-encoder structure. Each neural network may include an encoder and a decoder. For example, the neural network #1 included in the base station may include an encoder #1 and a decoder #1. The neural network #2 included in the terminal may include an encoder #2 and a decoder #2.

Input data X_{I} may be input to each neural network. Here, the input data X_{I} may include channel information and/or precoding information (for each specific frequency unit). The artificial neural network may be configured to dimensionally reduce the input data at a hidden layer and reconstruct the corresponding input again at an output layer. The input data X_{I} input to each neural network may be encoded into latent data Z (or Y) by the encoder. The latent data Z (or Y) in each neural network may correspond to compressed (or dimensionally-reduced) data from the input data X_{I}, identically or similarly to that described with reference to FIG. 3. The latent data Z (or Y) in each neural network may be decoded into output data X_{O} by the decoder. The output data X_{O} generated by each neural network in the above-described manner may be the same as or similar to the input data X_{I}. In other words, in each neural network, the decoder may reconstruct the input data from the latent data Z (or Y).

For training of the neural network #1 and/or the neural network #2, a ‘reference data set’ X_{REF} commonly referenced by the base station and the terminal may be configured. Here, the reference data set X_{REF} may correspond to a reference input data set X_{REF,I}, a reference output data set X_{REF,O}, or the like. Data constituting the reference input data set X_{REF,I} may be expressed as reference input data X_{C,I}. Data constituting the reference output data set X_{REF,O} may be expressed as reference output data X_{C,O}.

The input data X_{I} input to each neural network may include the reference input data X_{C,I}. The latent data Z (or Y) generated through encoding in each neural network may include reference latent data Z_{C} (or Y_{C}) corresponding to the reference input data X_{C,I}. For example, the encoder #1 of the neural network #1 may generate the first reference latent data Y_{C} corresponding to the reference input data X_{C,I}. The encoder #2 of the neural network #2 may generate the second reference latent data Z_{C} corresponding to the reference input data X_{C,I}.

Meanwhile, the output data X_{O} output from each neural network may include the reference output data X_{C,O}. In each neural network, the latent data Z (or Y) input to the decoder may include the reference latent data Z_{C} (or Y_{C}) corresponding to the reference output data X_{C,O}. For example, the decoder #1 of the neural network #1 may output the reference output data X_{C,O} corresponding to the first reference latent data Y_{C}. The decoder #2 of the neural network #2 may output the reference output data X_{C,O} corresponding to the second reference latent data Z_{C}.

The base station may transmit information on the reference input data X_{C,I}, information on the reference output data X_{C,O}, and information on the first reference latent data Y_{C} to the terminal. Through this, the performance of the CSI feedback operation may be improved.

Referring to FIG. 4B, the input data X_{I} input to the neural network #1 of the base station may include the reference input data X_{C,I}. The reference input data X_{C,I} may be included in the preconfigured reference input data set X_{REF,I}. In other words, the reference input data X_{C,I} input to the neural network #1 of the base station may be determined as values included in the reference input data set X_{REF,I}.

The encoder #1 of the base station may encode the input data X_{I} to generate the latent data Y. The generated latent data Y may include the first reference latent data Y_{C}. Here, the first reference latent data Y_{C} may mean a part corresponding to the reference input data X_{C,I} among the latent data Y generated by the encoder #1. The first reference latent data Y_{C} generated through encoding in the above-described manner may be included in the first reference latent data set Y_{REF} corresponding to the reference input data set X_{REF,I}. The decoder #1 of the base station may decode the latent data Y to generate the output data X_{O}. The generated output data X_{O} may include the reference output data X_{C,O}. The reference output data X_{C,O} may be included in the reference output data set X_{REF,O}.

Referring to FIG. 4C, the input data X_{I} input to the neural network #2 of the terminal may include the reference input data X_{C,I}. The reference input data X_{C,I} may be included in the preconfigured reference input data set X_{REF,I}. In other words, the reference input data X_{C,I} input to the neural network #2 of the terminal may be determined as values included in the reference input data set X_{REF,I}.

The encoder #2 of the terminal may generate the latent data Z by encoding the input data X_{I}. The generated latent data Z may include the second reference latent data Z_{C}. Here, the second reference latent data Z_{C} may mean a part corresponding to the reference input data X_{C,I} among the latent data Z generated by the encoder #2. The second latent data Z_{C} generated through encoding in the above-described manner may be included in the second reference latent data set Z_{REF} corresponding to the reference input data set X_{REF,I}. The decoder #2 of the terminal may decode the latent data Z to generate the output data X_{O}. The generated output data X_{O} may include the reference output data X_{C,O}. The reference output data X_{C,O} may be included in the reference output data set X_{REF,O}.

Information of the reference data set X_{REF} may be shared between the base station and the terminal. For example, the reference data set X_{REF} may include information of the reference input data set X_{REF,I} and/or information of the reference output data set X_{REF,O}. The base station may transmit information of the reference data set X_{REF} and/or information of the first reference latent data set Y_{REF} corresponding to the reference data set X_{REF} to the terminal. Alternatively, the information of the reference data set X_{REF} and/or the information of the first reference latent data set Y_{REF} may be shared between the base station and the terminal through a separate entity connected to the base station and/or the terminal. The shared information of the shared reference data set X_{REF} and/or the first reference latent data set Y_{REF} may be utilized in the CSI feedback procedure.

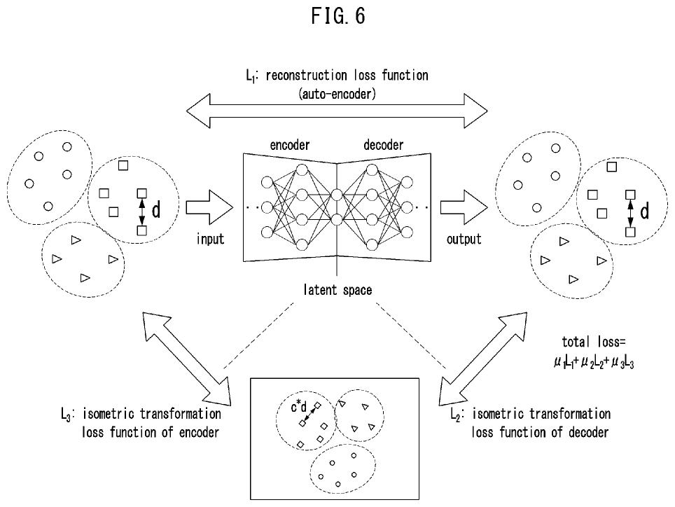

For example, the terminal may compare the first reference latent data set Y_{REF} corresponding to the reference data set X_{REF} in the neural network #1 of the base station and the second reference latent data Z_{REF} corresponding to the reference data set X_{REF} in the encoder #2 included in the neural network #2 of the terminal. In other words, the terminal may compare the first reference latent data set Y_{REF} and the second reference latent data set Z_{REF} corresponding to the same reference data set X_{REF}. The terminal may identify a reconstruction error or reconstruction loss, which is an error between the first reference latent data set Y_{REF} and the second reference latent data set Z_{REF}. The reconstruction loss identified in the above-described manner may be used for training of the neural network #2 of the terminal. For example, the terminal may perform supervised learning (or unsupervised learning) based on a predetermined loss function (hereinafter referred to as ‘total loss function’) for training of the neural network #2. The terminal may perform training in a direction in which a value of the total loss function decreases. The total loss function may be configured based on one or more loss functions. For example, the total loss function may be configured based on one or a combination of two or more loss functions among as a first loss function, a second loss function, and a third loss function. Here, the first loss function, second loss function, and third loss function may be the same as or similar to a first loss function, second loss function, and third loss function to be described with reference to FIG. 6. The terminal may perform training based on the total loss function configured based on one or a combination of two or more loss functions among the first loss function, second loss function, and third loss function. The total loss function may be configured to be fixed or variable.

In an exemplary embodiment of the communication system, the terminal may input second input data X_{I,2} to the neural network #2 configured for the CSI feedback procedure. Here, the second input data X_{I,2} may be input data for generating CSI feedback information. The second input data X_{I,2} may correspond to information such as CSI and CSI report. Alternatively, the second input data X_{I,2} may be generated based on the information such as CSI and CSI report.

The terminal may configure first feedback information for CSI feedback using the encoder #2 of the neural network #2. The terminal may transmit the first feedback information to the base station. The first feedback information transmitted in the above-described manner may correspond to second latent data Z₂ output from the encoder #2. The base station may receive the first feedback information transmitted from the terminal. The base station may decode the first feedback information transmitted from the terminal using the decoder #1 of the neural network #1 configured for the CSI feedback procedure. Through decoding in the decoder #1, first output data X_{O,1} may be generated. The first output data X_{O,1} generated in the above-described manner may correspond to a result of reconstructing the second input data X_{I,2} input to the encoder #2 in the terminal. Through this, the base station may receive the CSI feedback in a compressed (or dimensionally reduced) form from the terminal.

The technologies for the artificial neural networks or their structures mounted on the base station, terminal, etc. may correspond to technologies requiring security as an asset of each company. In order to maintain the security of artificial neural network technology, the entire structure of artificial neural network models for communication between the base station and the terminal may not be disclosed or shared. That is, only a part of the structures or minimal structures of the artificial neural network models for communication between the base station and the terminal may be shared. Alternatively, the structures of artificial neural network models for communication between the base station and the terminal may not be shared.

The base station and the terminal may independently configure their own artificial neural network (e.g., neural network #1 and neural network #2). The neural network #1 and the neural network #2 configured for the CSI feedback procedure between the base station and the terminal may not be configured identically to each other. Due to the discrepancy between the neural network #1 and the neural network #2, when the base station decodes the CSI feedback information, which is generated by the terminal through encoding by the neural network #2, by the neural network #1, there may occur a discrepancy between the input data at the terminal and the output data at the base station. In other words, due to the discrepancy between the neural network #1 and the neural network #2, the base station may misinterpret the CSI feedback information received from the terminal.

In the first exemplary embodiment of the artificial neural network structure, the reference data set X_{REF} may be shared between the base station and the terminal. For example, the base station and the terminal may directly share the reference data set X_{REF}. Alternatively, the base station may share the reference data set X_{REF} with a separate entity (hereinafter referred to as a ‘first entity’) connected to the base station and/or the terminal. Here, the first entity may be an upper entity of the base station and/or the terminal. The base station and/or the terminal may transmit and receive information between each other through the first entity. The first entity may manage artificial neural networks of the base station and/or the terminal. For example, the first entity may manage the neural network #2 of the terminal described with reference to FIGS. 4A to 4C. The first entity may perform training and/or update for the neural network #2 (or the encoder #2 and decoder #2 constituting the neural network #2).

The base station may generate or identify the first reference latent data set Y_{REF} corresponding to the reference data set X_{REF} based on the neural network #1. For example, the base station may generate the first reference latent data set Y_{REF} by encoding the reference input data set X_{REF,I} through the neural network #1 (or encoder #1 included in the neural network #1) of the base station. Alternatively, the base station may identify the first reference latent data set Y_{REF} corresponding to the reference output data set X_{REF,O} through the neural network #1 (or decoder #1 included in the neural network #1). The base station may transmit the first reference latent data set Y_{REF} to the terminal (or the first entity).

When the terminal directly manages the neural network #2 of the terminal, the base station may transmit the first reference latent data set Y_{REF} to the terminal. Based on the neural network #2, the terminal may generate or identify the second reference latent data set Z_{REF} corresponding to the reference input data set X_{REF}. The terminal may perform training of the neural network #2 in a direction such that an error between the second reference latent data set Z_{REF} and the first reference latent data set Y_{REF} is reduced. Accordingly, the CSI feedback information generated by the terminal based on the neural network #2 may be accurately interpreted by the neural network #1 in the base station. This may mean that the neural network #1 of the base station and the neural network #2 of the terminal are compatible with each other.

When the first entity manages the neural network #2 of the terminal, the base station may transmit the first reference latent data set Y_{REF} to the first entity. The first entity may generate or identify the second reference latent data set Z_{REF} corresponding to the reference data set X_{REF} based on the neural network #2. The first entity may perform training of the neural network #2 in a direction such that an error between the second reference latent data set Z_{REF} and the first reference latent data set Y_{REF} is reduced. The first entity may transmit information on the neural network #2 that has been updated or determined through training to the terminal. The terminal may update the neural network #2 based on the information received from the first entity. Accordingly, the CSI feedback information generated by the terminal based on the neural network #2 may be accurately interpreted by the neural network #1 in the base station. This may mean that the neural network #1 of the base station and the neural network #2 of the terminal are compatible with each other. When the first entity manages the neural network #2 of the terminal as described above, the training operation of the neural network #2 of the terminal may mean the training operation of the neural network #2 by the first entity (or through the first entity).

The reference input data set X_{REF,I} may be at least a part (or subset) of the entire input data set to be learned by the base station and/or the terminal. Accordingly, the terminal may follow the encoding scheme of the base station in encoding at least a part (i.e., reference input data set X_{REF,I}) of the entire input data. Meanwhile, the reference output data set X_{REF,O} may be at least a part (or subset) of the entire output data set to be learned by the base station and/or the terminal. Accordingly, the terminal may follow the decoding scheme of the base station in decoding at least a part (i.e., reference output data set X_{REF,O}) of the entire output data.

The configurations according to the first exemplary embodiment of the artificial neural network structure described above may be applied together with at least part of other exemplary embodiments within a range that does not conflict with the other exemplary embodiments disclosed in the present disclosure.

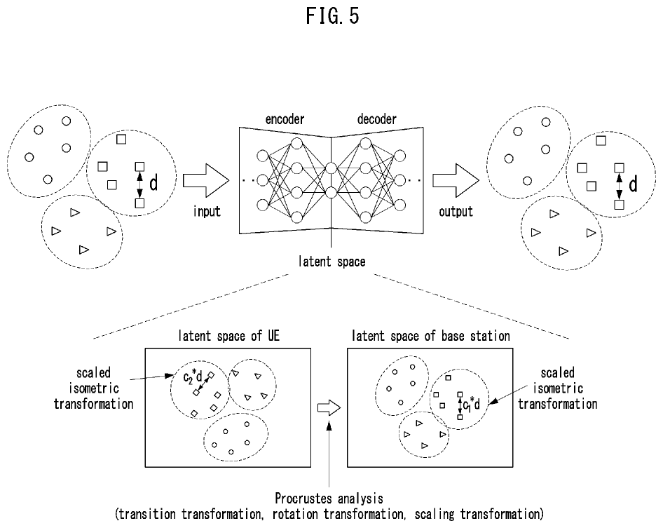

FIG. 5 is a conceptual diagram for describing first to third exemplary embodiments of an artificial neural network-based feedback method.

Referring to FIG. 5, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback operation between the base station and the terminal may be performed based on one or more artificial neural networks configured for a feedback procedure. Hereinafter, in describing the first exemplary embodiment of the artificial neural network-based feedback method (hereinafter, first exemplary embodiment of the feedback method), the second exemplary embodiment thereof (hereinafter, second exemplary embodiment of the feedback method), and the third exemplary embodiment thereof (hereinafter, third exemplary embodiment of the feedback method) with reference to FIG. 5, descriptions overlapping with those described with reference to FIGS. 1 to 4C may be omitted.

[First Exemplary Embodiment of Feedback Method]

In the first exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

In the first exemplary embodiment of the feedback method, each of the base station and the terminal may perform an intra-node alignment procedure and an inter-node alignment procedure.

1. Intra-Node Alignment Procedure

1-A. Each of the base station and the terminal may train the encoder and/or decoder of its own neural network, so that they have isometric transformation characteristics or scaled isometric transformation characteristics.

2. Inter-Node Alignment Procedure

2-A. The Base Station May Generate or Identify the First Reference Latent Data Set Y_{REF} corresponding to the reference data set X_{REF} based on the neural network #1. The base station may transmit information on the reference data set X_{REF} and/or the first reference latent data set Y_{REF} to the terminal (or the first entity managing the neural network #2 of the terminal).

2-B. The terminal (or the first entity managing the neural network #2 of the terminal) may generate or identify the second reference latent data set Z_{REF} corresponding to the reference data set X_{REF} based on the neural network #2. The terminal may perform a correction operation on a latent space (hereinafter referred to as ‘latent space correction operation’) of the neural network #2 so that a distance between the first reference latent data set Y_{REF} and the second reference latent data set Z_{REF} is reduced. Here, the latent space correction operation for the neural network #2 may correspond to a Procrustes' correction operation. The Procrustes correction may refer to correction that minimizes a distance between the latent data sets corresponding to the reference data set shared between different network nodes. The Procrustes correction operation may include operations such as a transition transformation operation, a rotation transformation operation, and a scaling transformation operation.

The isometric transformation characteristics may mean that a distance (hereinafter referred to as ‘first distance’) between first and second data in an input space (or output space) of a neural network is equal to a distance (hereinafter referred to as ‘second distance’) between first and second latent data corresponding to the first and second data in a latent space (or code space) of the neural network. The scaled isometric transformation characteristic may mean that the first distance and the second distance have an integer multiple relationship.

A latent data set generated in the latent space of the neural network trained to have the isometric transformation characteristics (or scaled isometric transformation characteristics) may have geometric similarity with the input data set (or output data set). In other words, the latent data set generated based on the neural network trained to have the isometric transformation characteristics (or scaled isometric transformation characteristics) may have geometric similarity with the input data set (or output data set). Accordingly, even when the base station and the terminal individually train the neural network #1 and the neural network #2, if there is similarity between learning data sets used, the latent data sets may also have similarity.

The isometric transformation or scaled isometric transformation may include transformations such as a transition transformation, rotation transformation, and scaling transformation. When different isometric transformations (or scaled isometric transformations) are applied to the same input data and/or output data, each of the latent spaces to which the (scaled) isometric transformation is applied may have a difference in terms of the transition transformation, rotation transformation, scaling transformation, and the like.

In order to correct the difference, the latent space correction operation may be performed. Specifically, the base station may transmit information on the reference data set and/or the first reference latent data set Y_{REF} to the terminal. The terminal may apply a Procrustes correction to the latent space of the neural network #2 so that the distance between the first reference latent data set Y_{REF} and the second reference latent data set Z_{REF} becomes small.

Each of the neural network #1 of the base station and the neural network #2 of the terminal may be trained to have (scaled) isometric transformation characteristics. Accordingly, the base station and the terminal may learn or acquire latent data similar to each other based on similar learning data or input data similar to each other. The terminal may acquire latent data by encoding feedback information using the encoder #2 of the neural network #2. The terminal may perform a latent space correction operation on the acquired latent data. The terminal may configure a feedback signal based on the corrected latent data. The base station receiving the feedback signal configured as described above may decode the (corrected) latent data using the decoder #1 of the neural network #1. Thus, the base station and the terminal may perform a feedback procedure using the neural networks with compatibility secured.

The configurations according to the first exemplary embodiment of the feedback method described above may be applied together with at least part of other exemplary embodiments within a range that does not conflict with the other exemplary embodiments disclosed in the present disclosure.

[Method of Training an Artificial Neural Network for Feedback for Each Network Node]

[Second Exemplary Embodiment of Feedback Method]

In the second exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

[Case #2-1]

In an exemplary embodiment of the communication system, the base station and/or terminal may perform the ‘intra-node alignment procedure’ described with reference to the first exemplary embodiment of the feedback method. For example, the terminal may train the encoder #2 and/or decoder #2 of its own neural network #2 to have isometric transformation characteristics or scaled isometric transformation characteristics.

On the other hand, in another exemplary embodiment of the communication system, the base station and/or terminal may not support the ‘isometric transformation characteristic training’. For example, the encoder #2 and/or decoder #2 of the neural network #2 of the terminal may not support the (scaled) isometric transformation characteristics. In other words, the terminal may not support training that enables the encoder #2 and/or decoder #2 of the neural network #2 to have (scaled) isometric transformation characteristics.

The base station may assume that the terminal's neural network #2 (i.e., encoder #2 and/or decoder #2) have the isometric transformation characteristics only when the terminal supports the isometric transformation characteristic training. To this end, the terminal may report whether the isometric transformation characteristic training is supported in the intra-node alignment procedure (or before or after the intra-node alignment procedure). The terminal may report such information to the base station based on a UE capability report. The base station may identify whether the terminal supports the isometric transformation characteristic training based on the report received from the terminal (e.g., UE capability report). When the terminal supports the isometric transformation characteristic training, the base station and/or the terminal may perform a feedback procedure in the same or similar manner as described with reference to the first exemplary embodiment of the feedback method.

Meanwhile, when the terminal does not support the isometric transformation characteristic training, the base station and/or the terminal may perform a feedback procedure in the same or similar manner as in Case #2-2 below.

[Case #2-2]

In an exemplary embodiment of the communication system, the terminal may not support the isometric transformation characteristic training. Alternatively, an artificial neural network (i.e., neural network #2) for the feedback procedure of the terminal may be configured independently from the base station. In this case, it may not be easy for the base station to interpret and reconstruct feedback information encoded and transformed using the neural network #2 in the terminal. In order to compensate for this problem, the terminal may provide supplementary information for the neural network #2 to the base station.

For example, the supplementary information for the neural network #2 may include information on a codebook that helps the base station interpret feedback information transformed based on the neural network #2. The supplementary information for the neural network #2 may include precoding information corresponding to each feedback information code point in the neural network #2. The supplementary information for the neural network #2 may include identification information for the neural network #2 (or its model).

Instead of directly transmitting information on the neural network #2 (or its model) to the base station, the terminal may transmit information on a codebook to be used by the base station to interpret latent data included in a feedback signal generated based on the neural network #2 of the terminal. Accordingly, the base station may support a feedback procedure based on the neural network #2 of the terminal.

When product models or manufacturers of different terminals are the same, the different terminals may include the same or similar artificial neural networks. The first terminal may be configured so that supplementary information for its own neural network #2 includes identification information (hereinafter, first identification information) for the neural network #2 (or its model). Accordingly, the base station may obtain information on a codebook corresponding to the neural network #2 of the first terminal and the first identification information corresponding to the neural network #2 of the first terminal. Meanwhile, the base station may transmit the first identification information included in the supplementary information received from the first terminal to the second terminal before receiving supplementary information from the second terminal.

When the identification information (hereinafter referred to as second identification information) of the neural network #2 (or its model) included in the second terminal overlaps with the first identification information, the base station may be expected to support a feedback procedure based on the neural network #2 of the terminal even if the base station does not receive supplementary information from the second terminal. In this case, the second terminal may configure the supplementary information to include only the second identification information excluding the information of the codebook and transmit it to the base station. When the second identification information received from the second terminal overlaps with the first identification information received from the first terminal, the base station may perform interpretation on a feedback signal received from the second terminal by using the information on the codebook received from the first terminal.

The configurations according to the second exemplary embodiment of the feedback method described above may be applied together with at least part of other exemplary embodiments within a range that does not conflict with the other exemplary embodiments disclosed in the present disclosure.

[Third Exemplary Embodiment of Feedback Method]

In the third exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In the third exemplary embodiment of the feedback method, a terminal supporting isometric transformation characteristic training may report (or provide) information that it supports the isometric transformation characteristic training to the base station. This reporting operation may be performed in the same or similar manner as in Case #2-1.

Such the isometric transformation characteristic training may be performed based on a loss function defined for (scaled) isometric transformation characteristics (hereinafter referred to as ‘isometric transformation loss function’). The base station may configure (or indicate) whether to apply an isometric transformation loss function to the terminal supporting the isometric transformation characteristic training.

1. The base station may configure a pre-agreement (or prior definition, etc.) indicating to the terminal whether to apply the isometric transformation loss function.

2. The base station may configure (or indicate) to the terminal whether to apply the isometric transformation loss function using a control signal or signaling.

2-A. Whether to apply the isometric transformation loss function may be configured through a semi-static signaling (e.g., radio resource control (RRC) signaling), dynamic signaling (e.g., dynamic control signaling, medium access control (MAC) control element (CE)), and/or the like.

2-B. Information on a (scaled) isometric transformation loss may be configured through a semi-static signaling, dynamic signaling, and/or the like. Here, the information on the (scaled) isometric transformation loss may include information on a form of the (scaled) isometric transformation loss, information on a reflection ratio of the (scaled) isometric transformation loss, and/or the like.

FIG. 6 is a conceptual diagram for describing a fourth exemplary embodiment of an artificial neural network-based feedback method.

Referring to FIG. 6, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback operation between the base station and the terminal may be performed based on one or more artificial neural networks configured for a feedback procedure. Hereinafter, in describing the fourth exemplary embodiment of the artificial neural network-based feedback method (hereinafter, fourth exemplary embodiment of the feedback method) with reference to FIG. 6, descriptions overlapping with those described with reference to FIGS. 1 to 5 may be omitted.

[Fourth Exemplary Embodiment of Feedback Method]

In the fourth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In the fourth exemplary embodiment of the feedback method, the base station and/or terminal may perform training of the artificial neural network for the feedback procedure. For such the training, one or more loss functions, or a combination thereof may be used. The one or more loss functions may include the following loss functions.

(1) First loss function: The first loss function may be defined based on a reconstruction error or reconstruction loss. The reconstruction loss may be defined based on a difference (or distance) between the first reference latent data set Y_{REF} determined based on the neural network #1 in the base station and the second reference latent data set Z_{REF} determined based on the neural network #2 in the terminal. For example, based on the first loss function, the terminal may perform training of the neural network #2 such that the difference between the first reference latent data set Y_{REF} and the second reference latent data set Z_{REF} is reduced. The first loss function may also be referred to as a ‘reconstruction loss function’. The first loss function may be expressed as ‘L₁’.

(2) Second loss function: The second loss function may be defined based on a (scaled) isometric transformation loss for the decoder. The second loss function may be an isometric transformation loss function. The second loss function may be expressed as ‘L₂’.

(3) Third loss function: The third loss function may be defined based on a (scaled) isometric transformation loss for the encoder. The third loss function may be an isometric transformation loss function. The third loss function may be expressed as ‘L₃’.

The total loss function may be defined based on a combination of one or more of the first loss function, second loss function, and third loss function. The total loss function Lₜₒₜₐₗ may be defined identically or similarly to Equation 1.

Lₜₒₜₐₗ=μ₁L₁+μ₂L₂+μ₃L₃ [Equation 1]

In Equation 1, μ₁, μ₂, and μ₃ may be weight coefficients having real values. A range of each value of μ₁, μ₂, and μ₃ may include 0. That is, whether or not each of the first loss function L₁, second loss function L₂, and third loss function L₃ is reflected to the total loss function and a reflection ratio thereof in the total loss function may be determined based on μ₁, μ₂, and μ₃. μ₁, μ₂, and μ₃ may be referred to as a first coefficient, second coefficient, and third coefficient, respectively. The first coefficient μ₁, second coefficient μ₂, and/or third coefficient μ₃ may be set as follows.

1. Between the base station and the terminal, a prior agreement (or pre-definition, etc.) may be established for the values of the first coefficient μ₁, second coefficient μ₂, and/or third coefficient μ₃.

2. The base station may configure (or indicate) information of the first coefficient μ₁, second coefficient μ₂, and/or third coefficient μ₃ to the terminal using a control signal or signaling.

2-A. The information of the first coefficient μ₁, second coefficient μ₂, and/or third coefficient μ₃ may be configured through semi-static signaling or dynamic signaling.

The configurations according to the fourth exemplary embodiment of the feedback method described above may be applied together with at least part of other exemplary embodiments within a range that does not conflict with the other exemplary embodiments disclosed in the present disclosure.

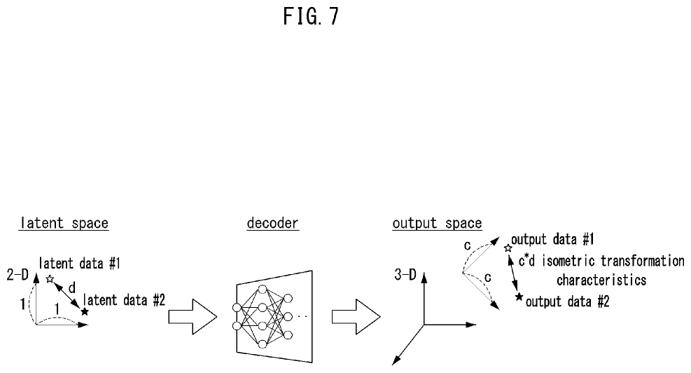

FIG. 7 is a conceptual diagram for describing fifth and sixth exemplary embodiments of an artificial neural network-based feedback method.

Referring to FIG. 7, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback operation between the base station and the terminal may be performed based on one or more artificial neural networks configured for a feedback procedure. Hereinafter, in describing the fifth exemplary embodiment of the artificial neural network-based feedback method (hereinafter, ‘fifth exemplary embodiment of the feedback method’) and the sixth exemplar embodiment thereof (hereinafter, ‘sixth exemplary embodiment of the feedback method’) with reference to FIG. 7, descriptions overlapping with those described with reference to FIGS. 1 to 6 may be omitted.

[Fifth Exemplary Embodiment of Feedback Method]

In the fifth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

[Case #5-1]

The decoder #1 of the neural network #1 and/or the decoder #2 of the neural network #2 may be expressed as a ‘decoder function’. The decoder function may be regarded as a function that corresponds variables in a d-dimensional space to variables in a D-dimensional space. For example, the decoder function may map variables in the d-dimensional latent space to variables in the D-dimensional output space. Here, d may be a natural number greater than or equal to 1, and D may be a natural number greater than or equal to d.

When the decoder is trained to have (scaled) isometric transformation characteristics, the decoder function may be regarded as having (scaled) isometric transformation characteristics locally at every point. A local transformation (e.g., linear transformation) of an arbitrary function may be approximated by a Jacobian matrix of the function. Thus, the local linear transformation of the decoder function may be approximated by a Jacobian matrix of the decoder function (e.g., D×d Jacobian matrix).

Based on the decoder function and the Jacobian matrix for the decoder function, a second loss function for the (scaled) isometric transformation characteristics of the decoder may be defined. For example, as column vectors of the D×d Jacobian matrix for the decoder function each have the same size (or unit length) and form an orthogonal set, the value of the second loss function for the decoder may be defined as small.

When the Jacobian matrix of the decoder function is trained to have the (scaled) isometric transformation characteristics, the decoder function may be expected to have the (scaled) isometric transformation characteristics. FIG. 7 shows an exemplary embodiment of the local linear transformation of the decoder that satisfies the (scaled) isometric transformation characteristics. Referring to FIG. 7, basis vectors (each corresponding to latent data) orthogonal to each other in the latent space may be transformed by the decoder function into vectors (each corresponding to output data) orthogonal to each other in the output space. The vectors transformed in the above-described manner may have the same size (e.g., c times the size of the basis vector) in the output space of the output data.

In this case, distances with respect to different latent data (or input data) may be maintained to be the same after the local transformation or may be transformed by scaling transformation (i.e., c times). In this case, it may be considered that the decoder (or decoder function) has isometric transformation characteristics or scaled isometric transformation characteristics.

[Case #5-2]

In an exemplary embodiment of the communication system, the base station may deliver the reference data set X_{REF} to the terminal. The reference data set X_{REF} may be a data set commonly referenced by the base station and the terminal in the input space (or output space). The base station and/or terminal may calculate an isometric transformation loss function based on the reference data set X_{REF}. For example, the following operations may be performed.

1. The base station may deliver the reference data set X_{REF} to the terminal.

2. The terminal may generate a graph GREF so that K adjacent elements are connected for an arbitrary element x with respect to the reference data set X_{REF}.

2-A. The adjacent elements may refer to elements whose distances with respect to the arbitrary element x is less than a specific threshold e. For example, d(x, y) may mean a distance between x and y. If d(x, y)<e, x and y may each correspond to a node (vertex) of the graph, and a connection relationship between x and y may correspond to an edge of the graph, which has d(x, y) as a weight. On the other hand, an edge may not be configured with an element whose distance with respect to the element x is greater than e. In this case, the weight may be expressed as 0.

3. For arbitrary elements x₁ and x₂ belonging to X_{REF}, the terminal may obtain a path with the shortest distance d (x₁, x₂) on the graph GREF, and calculate a distance d(z₁, z₂) for the path with respect to z₁=g(x₁) and z₂=g(x₂).

3-A. Here, the path with the shortest d (x₁, x₂) may mean a path in which a sum of weights (or distances) corresponding to respective edges is the smallest when moving from x₁ to x₂ along the edge(s) on the graph.

4. The terminal may define a difference (or distance) between d(z₁, z₂) and c*d(x₁, x₂) as a (scaled) isometric transformation loss. The terminal may perform training of the encoder #2 and/or decoder #2 so that the (scaled) isometric transformation loss becomes small.

The configurations according to the fifth exemplary embodiment of the feedback method described above may be applied together with at least part of other exemplary embodiments within a range that does not conflict with the other exemplary embodiments disclosed in the present disclosure.

[Sixth Exemplary Embodiment of Feedback Method]

In the sixth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In the sixth exemplary embodiment of the feedback method, the decoder #1 of the neural network #1 and/or the decoder #2 of the neural network #2 may be expressed as a ‘decoder function’. The decoder function may be regarded as a function that corresponds variables in a d-dimensional space to variables in a D-dimensional space. For example, the decoder function may map variables in the d-dimensional latent space to variables in the D-dimensional output space. Here, d may be a natural number greater than or equal to 1, and D may be a natural number greater than or equal to d.

When f denotes the decoder function, and J(f) denotes a Jacobian matrix of the decoder function, a second loss function for the (scaled) isometric transformation characteristics of the decoder may have a form corresponding to one of the following forms.

∥J(f)^{T}(z)·J(f)(z)−c₁·I_{d}∥_{F}² 1. Form 6-1:

1-A. In Form 6-1, z may mean a variable in the d-dimensional space (e.g., latent space). Here, z may be defined as z∈R^{d}. c₁ (or c) may mean a constant (or variable) representing a scale. c₁ (or c) may be either a constant (e.g., c₁=1) or one of variables to be optimized. ( )^{T} may mean a transpose operator for a matrix. I_{d} may mean a d×d identity matrix. ∥·∥_{F}² may mean an L₂ norm or a Frobenius norm.

1-B. Form 6-1 may mean a loss at a specific z. The total loss function may be in a form of summing or averaging losses according to Form 6-1 for all or some of z.

σₘₐₓ(J(f)^{T}(z)·J(f)(z)−c₁·I_{d}) 2. Form 6-2:

2-A. In Form 6-2, z may mean a variable in the d-dimensional space (e.g., latent space). Here, z may be defined as z∈Rd. c₁ (or c) may mean a constant (or variable) representing a scale. c₁ (or c) may be either a constant (e.g., c₁=1) or one of variables to be optimized. ( )^{T} may mean a transpose operator for a matrix. I_{d} may mean a d×d identity matrix. σ^{max}(·) may mean a spectral norm. The spectral norm may be interpreted as an operation to find the largest singular value.

1-B. Form 6-2 may mean a loss at a specific z. The total loss function may be in a form of summing or averaging losses according to Form 6-2 for all or some of z.

E_{z,u}{(∥J(f)(z)·u∥−c₁·1)²} 3. Form 6-3:

3-A. In Form 6-3, z may mean a variable in the d-dimensional space (i.e., latent space). Here, z may be defined as z∈^{Rd}. c₁ (or c) may mean a constant (or variable) representing a scale. c₁ (or c) may be either a constant (e.g., c₁=1) or one of variables to be optimized. ( )^{T} may mean a transpose operator for a matrix. u may mean a unit vector on a unit sphere defined in the d-dimensional space. E_{z,u}{·} may mean an average operation for z and u. ∥·∥ may mean an L1 norm or an L2 norm. In actual implementation, the average operation for z and u may be approximated by an operation for obtaining a sample mean for a plurality of samples for z and u.

E_{z,u}{∥u^{T}·J(f)(z)^{T}·J(f)(z)∥²}/[E_{z,u}{∥J(f)(z)·u∥²}]² 4. Form 6-4:

4-A. In Form 6-4, z may mean a variable in the d-dimensional space (i.e., latent space). Here, z may be defined as z∈R^{d}. c₁ (or c) may mean a constant (or variable) representing a scale. c₁ (or c) may be either a constant (e.g., c₁=1) or one of variables to be optimized. ( )^{T} may mean a transpose operator for a matrix. u may mean a vector following a standard normal distribution. E_{z,u}{·} may mean an average operation for z and u. ∥·∥ may mean an L1 norm or an L2 norm. In actual implementation, the average operation for z and u may be approximated by an operation for obtaining a sample mean for a plurality of samples for z and u.

E_{z}{Tr(H(z)²)}/[E_{z}{Tr(H(z))}]² where H(z)=J(f)(z)^{T}·J(f)(z) 5. Form 6-5:

5-A. In Form 6-5, z may mean a variable in the d-dimensional space (e.g., latent space). Here, z may be defined as z∈R^{d}. ( )^{T} may mean a transpose operator for a matrix. Tr( ) may mean a trace operation on a matrix. E_{z,u}{·} may mean an average operation for z. ∥·∥ may mean an L1 norm or an L2 norm. In actual implementation, the average operation for z and u may be approximated by an operation for obtaining a sample mean for a plurality of samples for z and u.

The configurations according to the sixth exemplary embodiment of the feedback method described above may be applied together with at least part of other exemplary embodiments within a range that does not conflict with the other exemplary embodiments disclosed in the present disclosure.

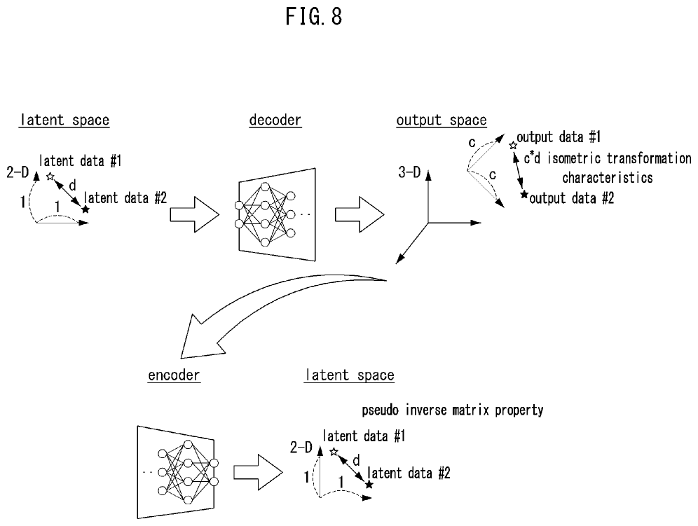

FIG. 8 is a conceptual diagram for describing seventh and eighth exemplary embodiments of an artificial neural network-based feedback method.

Referring to FIG. 8, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback operation between the base station and the terminal may be performed based on one or more artificial neural networks configured for a feedback procedure. Hereinafter, in describing the seventh exemplary embodiment of the artificial neural network-based feedback method (hereinafter, ‘seventh exemplary embodiment of the feedback method’) and the eighth exemplar embodiment thereof (hereinafter, ‘eighth exemplary embodiment of the feedback method’) with reference to FIG. 8, descriptions overlapping with those described with reference to FIGS. 1 to 7 may be omitted.

[Seventh Exemplary Embodiment of Feedback Method]

In the seventh exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In the seventh exemplary embodiment of the feedback method, the encoder #1 of the neural network #1 and/or the encoder #2 of the neural network #2 may be expressed as an ‘encoder function’. The encoder function may be regarded as a function that corresponds variables in a D-dimensional space to variables in a d-dimensional space. For example, the encoder function may map variables in the D-dimensional input space to variables in the d-dimensional latent space. Here, d may be a natural number greater than or equal to 1, and D may be a natural number greater than or equal to d.

When the encoder is trained to have (scaled) isometric transformation characteristics, the encoder function may be regarded as having (scaled) isometric transformation characteristics locally at every point. The local transformation (e.g., linear transformation) of an arbitrary function may be approximated by a Jacobian matrix of the function. Thus, the local linear transformation of the encoder function may be approximated by a Jacobian matrix of the encoder function (e.g., a d×D Jacobian matrix).

Based on the encoder function and the Jacobian matrix for the encoder function, a third loss function for the (scaled) isometric transformation characteristics of the encoder may be defined. For example, as row vectors of the d×D Jacobian matrix for the encoder function each have the same size (or unit length) and form an orthogonal set, a value of the third loss function for the encoder may be defined as small.

When the Jacobian matrix of the encoder function is trained to have (scaled) isometric transformation characteristics, the encoder function may be expected to have (scaled) isometric transformation characteristics. Alternatively, when the Jacobian matrix of the encoder function has (scaled) isometric transformation characteristics, a local (e.g., linear) transformation of the encoder may be expressed as a pseudo inverse matrix of a local (linear) transformation of the decoder identical or similar to that described with reference to FIG. 7. This may be referred to as ‘pseudo inverse matrix property’.

FIG. 7 shows an exemplary embodiment of the local linear transformation of the decoder and the local linear transformation of the encoder that satisfy the (scaled) isometric transformation characteristics. Referring to FIG. 7, basis vectors (each corresponding to latent data) orthogonal to each other in the latent space may be transformed by the encoder function into vectors (each corresponding to output data) orthogonal to each other in the output space. The vectors transformed in the above-described manner may have the same size (e.g., c times the size of the basis vector) in the output space of the output data.

In this case, distances with respect to different latent data (or input data) may be maintained to be the same or may be transformed by scaling (i.e., c times) transformation after the local transformation. In this case, the encoder (or encoder function) may be regarded as having isometric transformation characteristics or scaled isometric transformation characteristics.

The configurations according to the seventh exemplary embodiment of the feedback method described above may be applied together with at least part of other exemplary embodiments within a range that does not conflict with the other exemplary embodiments disclosed in the present disclosure.

[Eighth Exemplary Embodiment of Feedback Method]

In the eighth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In the eighth exemplary embodiment of the feedback method, the decoder #1 of the neural network #1 and/or the decoder #2 of the neural network #2 may be expressed as a ‘decoder function’. The decoder function may be regarded as a function that corresponds variables in a d-dimensional space to variables in a D-dimensional space. For example, the decoder function may map variables in the d-dimensional latent space to variables in the D-dimensional output space. Meanwhile, the encoder #1 of the neural network #1 and/or the encoder #2 of the neural network #2 may be expressed as an ‘encoder function’. The encoder function may be regarded as a function that corresponds variables in the D-dimensional space to variables in the d-dimensional space. For example, the encoder function may map variables in the D-dimensional latent space to variables in the d-dimensional output space. Here, d may be a natural number greater than or equal to 1, and D may be a natural number greater than or equal to d.

When the encoder function is denoted as g and a Jacobian matrix of the encoder function is denoted as J(g), a third loss function for the (scaled) isomeric transformation characteristics of the encoder may have a form corresponding to one of the following forms.

∥J(g)(x)·J(g)^{T}(x)−c₂·I_{d}∥_{F}² Form 8-1:

1-A. In Form 8-1, x may mean a variable in the D-dimensional space (e.g., input space). Here, x may be defined as x∈R^{D}. c₂ (or c) may mean a constant (or variable) representing a scale. c₂ (or c) may be either a constant (e.g., c₂₌₁) or one of variables to be optimized. ( )^{T} may mean a transpose operator for a matrix. I_{d} may mean a d×d identity matrix. ∥·∥_{F}² may mean an L₂ norm or a Frobenius norm.

1-B. Form 8-1 may mean a loss at a specific x. The total loss function may be in a form of summing or averaging losses according to Form 8-1 for all or some of x.

σₘₐₓ(J(g)(x)·J(g)^{T}(x)−c₂·I_{d}) Form 8-2:

2-A. In Form 8-2, x may mean a variable in the D-dimensional space (e.g., input space). Here, x may be defined as x∈R^{D}. c₂ (or c) may mean a constant (or variable) representing a scale. c₂ (or c) may be either a constant (e.g., c₂=1) or one of variables to be optimized. ( )^{T} may mean a transpose operator for a matrix. I_{d} may mean a d×d identity matrix. σmax(·) may mean a spectral norm. The spectral norm may be interpreted as an operation to find the largest singular value.

2-B. Form 8-2 may mean a loss at a specific x. The total loss function may be in a form of summing or averaging losses according to Form 8-2 for all or some of x.

E_{x,u}{(∥u^{T}·J(g)(x)∥−c₂·1)²} Form 8-3:

3-A. In Form 8-3, x may refer to a variable in the D-dimensional space (e.g., input space). Here, x may be defined as x∈R^{D}. c₂ (or c) may mean a constant (or variable) representing a scale. c₂ (or c) may be either a constant (e.g., c₂₌₁) or one of variables to be optimized. ( )^{T} may mean a transpose operator for a matrix. u may mean a unit vector on a unit sphere defined in the d-dimensional space. E_{x,u}{ } may mean an average operation for x and u. ∥·∥ may mean an L1 norm or an L2 norm. In actual implementation, the average operation for x and u may be approximated by an operation for obtaining a sample mean for a plurality of samples for x and u.

In an exemplary embodiment of the communication system, when f denotes the decoder function of the artificial neural network for the feedback procedure, J(f) denotes a Jacobian matrix of the decoder function, and the decoder is trained under a condition of J(f)^{T}(z)·J(f)(z)=c₁·I_{d}, a relation ship c₂=(1/c₁)² may be established.

The configurations according to the eighth exemplary embodiment of the feedback method described above may be applied together with at least part of other exemplary embodiments within a range that does not conflict with the other exemplary embodiments disclosed in this disclosure.

Referring to the above-described second to eighth exemplary embodiments of the feedback method, [artificial neural network training method for feedback in each network node] has been introduced. Hereinafter, with reference to the ninth to twelfth exemplary embodiments of the feedback method, [inter-network node artificial neural network alignment scheme for feedback] will be introduced.

[Inter-Network Node Artificial Neural Network Alignment Scheme for Feedback]

[Ninth Exemplary Embodiment of Feedback Method]

In the ninth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

The base station (or terminal) may deliver information of the reference data set X_{REF} to the terminal (or base station) in one or more of the following schemes.

1. A scheme of applying a pre-agreed (or pre-defined) codebook

2. A scheme of delivering information of the reference data set X_{REF} through a control signal or signaling

2-A. Information of the reference data set X_{REF} may be delivered through semi-static signaling (e.g., radio resource control (RRC) signaling), dynamic signaling (e.g., dynamic control signaling, medium access control (MAC) control element (CE)), and/or the like.

Meanwhile, the base station (or terminal) may obtain a latent data set (e.g., first reference latent data set Y_{REF}) corresponding to the reference data set X_{REF}. The base station (or terminal) may deliver the information of the first reference latent data set Y_{REF} to the terminal (or base station) in one or more of the following schemes.

1. A scheme of applying a pre-agreed (or pre-defined) correspondence relationship (e.g., encoding, embedding, etc.)

2. A scheme of transmitting information of the first reference latent data set Y_{REF} through a control signal or signaling

2-A. The information of the reference data set X_{REF} may be delivered through semi-static signaling or dynamic signaling.

Here, the base station (or terminal) may determine the first reference latent data set Y_{REF} so that a centroid corresponding to an average of positions of data elements constituting the first reference latent data set Y_{REF} is located at an origin of the latent space. Alternatively, the base station (or terminal) may apply a correction on the first reference latent data set Y_{REF} so that the centroid corresponding to the average of positions of data elements constituting the first reference latent data set Y_{REF} is located at the origin of the latent space.

In an exemplary embodiment of the communication system, even when shapes of artificial neural networks for feedback included in different network nodes are geometrically identical or similar to each other, if coordinate systems for recognizing latent data in the respective latent spaces are different, there may occur a problem in which another network node misinterprets feedback information encoded by an encoder of an artificial neural network for feedback in a specific network node.

In order to align the coordinates of the latent spaces of the different network nodes, information of a reference data set that can be commonly referred to by the different network nodes may be shared therebetween. For example, network nodes (e.g., base station and terminal) may assume precoding matrixes corresponding to respective code points of a Type 2 codebook as reference input data that the network nodes can commonly refer to. Thereafter, a correction may be performed so that latent data (or codes) of the artificial neural network for feedback corresponding to the Type 2 codebook are matched as much as possible between the different network nodes. To this end, information of a latent data set (or latent variables) corresponding to the reference data set as well as information on the reference data set may need to be shared between the network nodes.

[Case #9-1]

In an exemplary embodiment of the communication system, the neural network #1 of the base station and the neural network #2 of the terminal (or artificial neural networks of different network nodes) may be trained based on one or more loss functions defined based on isometric transformation characteristics. Accordingly, latent spaces of the artificial neural networks of different network nodes may be constructed to be geometrically similar to each other. In addition, as a reference data set (e.g., reference input data set, reference output data set, etc.) is shared between the network nodes, the latent spaces of the artificial neural networks of different network nodes may be aligned.

Meanwhile, in an exemplary embodiment of the communication system, an operator network may be configured by one or more network providers (i.e., vendors). If network providers of a first cell and a second cell are different when the terminal performs a handover procedure from the first cell to the second cell, a reference data set (e.g., X_{REF}) for training the artificial neural network, and/or a reference latent data set (e.g., first reference latent data set Y_{REF}) corresponding to the data set may be changed.

The network (or base station) may allow the terminal to handover from the first cell to the second cell. Here, the network may inform the terminal of changes in the reference data set and/or latent data set according to the handover. For example, when allowing the handover, the network may provide the terminal with information on the reference data set X_{REF} corresponding to the second cell and/or information on the first reference latent data set Y_{REF} corresponding to the reference data set X_{REF} corresponding to the second cell. During the handover, the terminal may perform training based on the information on the reference data set X_{REF} corresponding to the second cell and/or the information on the first reference latent data set Y_{REF} provided from the network. Accordingly, compatibility between the artificial neural network of the terminal and the artificial neural network of the second cell to which the terminal handed over may be secured.

[Case #9-2]

In an exemplary embodiment of the communication system, information of the reference data set X_{REF} may be shared between different network nodes. The shared reference data set X_{REF} may be used for training to secure compatibility between artificial neural networks of the different network nodes.

Meanwhile, in a CSI feedback procedure, a CSI feedback size may vary according to a transmission band and/or a transmission type. The reference data set X_{REF} (or reference data constituting the reference data set X_{REF}) may be differently defined for each CSI feedback size. The reference data set X_{REF} may be determined identically or differently according to one or more of the following conditions.
CSI feedback size
CSI payload
Code rate of CSI feedback
Compression ratio

Information on the reference data set X_{REF} (or reference data constituting the reference data set X_{REF}) determined to be the same or different according to the one or more conditions may be shared between the different network nodes. Training of the artificial neural networks may be performed identically or differently according to the one or more conditions based on the information of the reference data set X_{REF} determined identically or differently according to the one or more conditions.

The configurations according to the ninth exemplary embodiment of the feedback method described above may be applied together with at least part of other exemplary embodiments within a range that does not conflict with the other exemplary embodiments disclosed in the present disclosure.

[Tenth Exemplary Embodiment of Feedback Method]

In the tenth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In an exemplary embodiment of the communication system, the neural network #1 of the base station and the neural network #2 of the terminal (or artificial neural networks of different network nodes) may be trained based on one or more loss functions defined based on isometric transformation characteristics. Accordingly, latent spaces of the artificial neural networks of different network nodes may be constructed to be geometrically similar to each other. In addition, as a reference data set (e.g., reference input data set, reference output data set, etc.) is shared between the network nodes, the latent spaces of the artificial neural networks of different network nodes may be aligned.

In an exemplary embodiment of the communication system, correction on latent spaces (or coordinate systems referenced by the latent spaces) of the artificial neural networks of two different network nodes may be performed. Such the correction may be performed by aligning a centroid of a latent space of an artificial neural network of one network node among the two network nodes with a centroid of a latent space of an artificial neural network of the other network node. For example, the centroid of the latent space of the neural network #2 of the terminal may be corrected based on the centroid of the latent space of the neural network #1 of the base station.

Meanwhile, in another exemplary embodiment of the communication system, correction on latent spaces (or coordinate systems referenced by the latent spaces) of artificial neural networks of a plurality of different network nodes may be performed. Such the correction may be performed by aligning a centroid of each latent space of the artificial neural networks of the plurality of different network nodes with a common point.

For example, the reference data set X_{REF} may be shared among a plurality of different network nodes (e.g., first base station, second base station, first terminal, second terminal, etc.). Each of the plurality of network nodes may generate a reference latent data set using an encoder of its own artificial neural network. Each of the plurality of network nodes may identify a centroid corresponding to the reference latent data set generated in the above-described manner. For example, each of the plurality of network nodes may determine the centroid corresponding to the reference latent data set by calculating an average value of latent data elements (or positions thereof) constituting the reference latent data set generated by its own encoder. Each of the plurality of network nodes may perform correction (e.g., transition transformation) such that the centroid corresponding to the identified reference latent data set is located at an origin of each latent space.

The configurations according to the tenth exemplary embodiment of the feedback method described above may be applied together with at least part of other exemplary embodiments within a range that does not conflict with the other exemplary embodiments disclosed in the present disclosure.

[Eleventh Exemplary Embodiment of Feedback Method]

In the eleventh exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In an exemplary embodiment of the communication system, information of the reference data set X_{REF} may be shared between the base station and the terminal. The base station may generate the first reference latent data set Y_{REF} from the reference data set X_{REF} by using the encoder #1. The terminal may generate the second reference latent data set Z_{REF} from the reference data set X_{REF} by using the encoder #2. The base station may provide information on the first reference latent data set Y_{REF} generated by the encoder #1 to the terminal. The terminal may identify a correction operation to minimize a distance between the first reference latent data set Y_{REF} generated by the encoder #1 of the base station and the second reference latent data set Z_{REF} generated by the encoder #2 of the terminal. Such the correction operation may be referred to as a ‘latent space correction operation’. The latent space correction operation may include operations such as transition transformation, rotation transformation, and/or scaling transformation.

The terminal may correct a latent space (or its coordinate system) of the neural network #2 based on the correction operation identified in the above-described manner. Alternatively, the terminal may correct latent data #2, which is output by encoding input data including feedback information in the encoder #2, based on the correction operation identified in the above-described manner. The terminal may configure a feedback signal based on the latent data corrected based on the correction operation as described above, and may transmit the configured feedback signal to the base station.

Here, the reference data set X_{REF}, the first reference latent data set Y_{REF}, the second reference latent data set Z_{REF}, etc. may be expressed as a matrix in which each column vector corresponds to a specific single data element. For example, when A means a set of N data elements, it may be expressed as a matrix composed of N column vectors, such as A={a₁, a₂, . . . , a_{N}}. In this case, a distance between data sets may be calculated as a distance between matrices corresponding to the data sets. The distance between matrices may be calculated as a Frobenius norm for a difference between matrices. As an example, a distance between a matrix A and a matrix B may be defined as a Frobenius norm for (A−B)

The configurations according to the eleventh exemplary embodiment of the feedback method described above may be applied together with at least part of other exemplary embodiments within a range that does not conflict with the other exemplary embodiments disclosed in the present disclosure.

[Twelfth Exemplary Embodiment of Feedback Method]

In the twelfth exemplary embodiment of the feedback method, the base station and the terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may perform an operation of transmitting and receiving feedback information based on the neural network #1 and the neural network #2.

In an exemplary embodiment of the communication system, information of the reference data set X_{REF} may be shared between the base station and the terminal. The base station may generate the first reference latent data set Y_{REF} from the reference data set X_{REF} by using the encoder #1. The terminal may generate the second reference latent data set Z_{REF} from the reference data set X_{REF} by using the encoder #2. The terminal (or base station) may perform correction on the first reference latent data set Y_{REF} and/or the second reference latent data set Z_{REF} based on one or more of the following steps.

Step 1. Identifying the first reference latent data set Y_{REF} and/or the second reference latent data set Z_{REF} corresponding to the reference latent data set X_{REF}

Step 2. Deriving a corrected first reference latent data set Y″_{REF} by applying a transition transformation T_{Y} such that a centroid corresponding to the first reference latent data set Y_{REF} becomes an origin of the latent space

Step 3. Deriving a corrected second reference latent data set Z″_{REF} by applying a transition transformation T_{Z} such that a centroid corresponding to the second reference latent data set Z_{REF} becomes an origin of the latent space.

Step 4. Deriving a rotation transformation Q and/or a scaling transformation k for correcting the second reference latent data set Z″_{REF} such that a distance between the corrected first reference latent data set Y″_{REF} and the corrected second reference latent data set Z″_{REF} is minimized.

4-A. Q and/or k may be derived as follows.

Q=UV^{T} 4-A-i.

Here, UΣV^{T} may be SVD (Z″_{REF}^{T}*Y″_{REF}). SVD( ) may mean singular value decomposition.

k=tr(Σ)/tr(Z″_{REF}^{T}*Z″_{REF}) 4-A-ii.

Here, tr( ) may mean a diagonal trace operation.

Step 5. Deriving corrected latent data z* by applying the transition transformation T_{Z} determined in Step 3, the rotation transformation Q determined in Step 4, and the scaling transformation k, etc. to arbitrary latent data z

5-A. The correction operation based on the rotation transformation Q, the scaling transformation k, etc. identified in Step 4 may be applied as follows.

z*=k*z*Q 5-A-i.

Step 6. Transforming the corrected latent data z* into latent variables that can be interpreted by the neural network #1 (or neural network #2) of the base station (or terminal) by applying an inverse transform to the transition transformation T_{Y} identified in Step 2

Step 7. Reporting (or transmitting) values of the latent variables converted as in Step 6 or quantized values of the latent variable values as feedback information to the base station (or terminal)

Here, the reference data set X_{REF}, the first reference latent data set Y_{REF}, the second reference latent data set Z_{REF}, etc. may be expressed as a matrix in which each column vector corresponds to a specific single data element. For example, when A means a set of N data elements, it may be expressed as a matrix composed of N column vectors, such as A={a₁, a₂, . . . , a_{N}}. In this case, a distance between the data sets may be calculated as a distance between matrices corresponding to the data sets. The distance between matrices may be calculated as a Frobenius norm for a difference between matrices. As an example, the distance between a matrix A and a matrix B may be defined as a Frobenius norm for (A−B).

The configurations according to the twelfth exemplary embodiment of the feedback method described above may be applied together with at least part of other exemplary embodiments within a range that does not conflict with the other exemplary embodiments disclosed in the present disclosure.

According to an exemplary embodiment of an artificial neural network-based feedback method and apparatus in a communication system, communication nodes (e.g., base station and terminal) in the communication system may include artificial neural networks for a feedback procedure (e.g., CSI feedback procedure). In a transmitting node that transmits feedback information, a compressed form of the feedback information may be generated through an encoder of an artificial neural network. A receiving node that receives the feedback information may receive the compressed form of the feedback information from the transmitting node. The receiving node may restore the original feedback information from the compressed form of the feedback information through a decoder of an artificial neural network. For such the feedback procedure, operations for ensuring compatibility based on isometric transformation characteristics of the artificial neural networks may be performed. Through this, the performance of the artificial neural network-based feedback operation can be improved.

However, the effects that can be achieved by the exemplary embodiments of the artificial neural network-based feedback method and apparatus in the communication system are not limited to those mentioned above, and other effects not mentioned may be clearly understood by those of ordinary skill in the art to which the present disclosure belongs from the configurations described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a first communication node, comprising:
determining a latent space correction operation including a transformation operation for correcting latent data output from a first encoder of a first artificial neural network corresponding to the first communication node, based on information of a reference data set provided from a second communication node;
encoding first input data including first feedback information through the first encoder;
correcting first latent data output from the first encoder based on the determined latent space correction operation; and
transmitting a first feedback signal including the corrected first latent data to the second communication node,
wherein the corrected first latent data is decoded into first output data corresponding to the first input data in a second decoder of a second artificial neural network corresponding to the second communication node.

2. The operation method according to claim 1, further comprising, before the determining of the latent space correction operation, performing first learning so that at least the first encoder has isometric transformation characteristics, wherein the isometric transformation characteristics mean that a distance between two arbitrary input values input to the first encoder and a distance between two output values corresponding to the two input values and output from the first encoder have a k-fold relationship, k being a positive real value.

3. The operation method according to claim 1, further comprising, before the determining of the latent space correction operation,
transmitting, to the second communication node, a first capability report indicating that the first communication node does not support a learning operation for isometric transformation characteristics of the first artificial neural network; and
transmitting, to the second communication node, information of a first codebook corresponding to the first artificial neural network and first identification information,
wherein the first identification information includes at least one of identification information of the first artificial neural network or identification information of the first codebook.

4. The operation method according to claim 1, further comprising, before the determining of the latent space correction operation,
transmitting, to the second communication node, a first capability report indicating that the first communication node does not support a learning operation for isometric transformation characteristics of the first artificial neural network;
receiving, from the second communication node, second identification information of a codebook corresponding to a third artificial neural network of a third communication node;
comparing the second identification information with first identification information; and
when the first and second identification information overlap, determining that the second communication node has previously acquired information of a first codebook corresponding to the first artificial neural network through the third communication node.

5. The operation method according to claim 1, further comprising, before the determining of the latent space correction operation, performing second learning for the first artificial neural network,
wherein the second learning is performed based on a total loss function determined by a combination of one or more loss functions of a first loss function, a second loss function, or a third loss function, and
wherein the first loss function is defined based on a relationship between a second encoder of the second artificial neural network of the second communication node and the first encoder, the second loss function is defined based on input values and output values of the first decoder of the first artificial neural network, and the third loss function is defined based on input values and output values of the first encoder.

6. The operation method according to claim 5, wherein the first loss function is defined based on a size of an error between a first latent data set that is a result of encoding the reference data set through the first encoder and a second latent data set that is a result of encoding the reference data set through the second encoder.

7. The operation method according to claim 5, further comprising, before the performing of the second learning,
receiving, from the second communication node, information on a first coefficient corresponding to the first loss function, a second coefficient corresponding to the second loss function, and a third coefficient corresponding to the third loss function; and
determining the total loss function based on the first to third coefficients,
wherein the first to third coefficients are real numbers of 0 or more, respectively.

8. The operation method according to claim 1, wherein the transformation operation included in the latent space correction operation is determined to include at least one of a transition transformation operation, a rotation transformation operation, or a scaling transformation operation for the latent data output from the first encoder within a first latent space corresponding to an output end of the first encoder.

9. The operation method according to claim 1, wherein the determining of the latent space correction operation comprises:
receiving, from the second communication node, information of a second latent data set generated based on the reference data set in a second encoder of the second artificial neural network included in the second communication node;
generating a first latent data set located in a first latent space corresponding to an output end of the first encoder by encoding the reference data set through the first encoder; and
determining the transformation operation included in the latent space correction operation such that a distance between the first and second latent data sets is minimized when the first latent data set is corrected based on the latent space correction operation.

10. The operation method according to claim 9, wherein the determining of the transformation operation comprises:
identifying positions of one or more data elements constituting the first latent data set in the first latent space;
calculating an average of the positions and identifying a centroid of the positions; and
determining a first transition transformation operation for making the identified centroid an origin of the first latent space,
wherein the second latent data set is corrected by the second communication node based on a second transition transformation operation based on an origin of a second latent space corresponding to an output end of the second encoder.

11. The operation method according to claim 9, wherein the first and second latent data sets correspond to first and second matrixes each composed of one or more column vectors respectively corresponding to one or more data elements, and the determining of the transformation operation comprises:
identifying a first transformation matrix such that a distance between a third matrix generated by multiplying the first transformation matrix by the first matrix and the second matrix is minimized; and
determining the transformation operation corresponding to the first transformation matrix.

12. An operation method of a first communication node, comprising:
transmitting, to a second communication node, information related to a reference data set required for determining a latent space correction operation including a transformation operation for correcting latent data output from a second encoder of a second artificial neural network corresponding to the second communication node;
receiving a first feedback signal from the second communication node;
obtaining first latent data included in the first feedback signal;
performing a decoding operation on the first latent data based on a first decoder of a first artificial neural network corresponding to the first communication node; and
obtaining first feedback information based on first output data output from the first decoder,
wherein the first latent data included in the first feedback signal corresponds to a result obtained by correcting second latent data output from the second encoder based on the latent space correction operation, and the second latent data is generated by encoding first input data including second feedback information corresponding to the first feedback information through the second encoder.

13. The operation method according to claim 12, further comprising, before the receiving of the first feedback signal,
receiving, from the second communication node, a first capability report indicating that the second communication node does not support a learning operation for isometric transformation characteristics of the second artificial neural network; and
receiving, from the second communication node, information of a first codebook corresponding to the second artificial neural network and first identification information,
wherein the first identification information includes at least one of identification information of the second artificial neural network or identification information of the first codebook.

14. The operation method according to claim 12, further comprising, before the receiving of the first feedback signal,
receiving, from a third communication node, information of a second codebook corresponding to a third artificial neural network corresponding to the third communication node and second identification information;
receiving, from the second communication node, a first capability report indicating that the second communication node does not support a learning operation for isometric transformation characteristics of the second artificial neural network; and
transmitting the second identification information to the second communication node.

15. The operation method according to claim 12, further comprising, before the receiving of the first feedback signal, transmitting, to the second communication node, a first signaling for second learning for the second artificial neural network of the second communication node,
wherein the second learning is performed based on a total loss function determined by a combination of one or more loss functions of a first loss function, a second loss function, or a third loss function, and
wherein the first loss function is defined based on a relationship between a first encoder of the first artificial neural network of the first communication node and the second encoder, the second loss function is defined based on input values and output values of the second decoder of the second artificial neural network, and the third loss function is defined based on input values and output values of the second encoder.

16. The operation method according to claim 15, wherein the first loss function is defined based on a size of an error between a first latent data set that is a result of encoding the reference data set through the first encoder and a second latent data set that is a result of encoding the reference data set through the second encoder.

17. The operation method according to claim 15, wherein the first signaling includes information on a ratio of a first coefficient corresponding to the first loss function, a second coefficient corresponding to the second loss function, and a third coefficient corresponding to the third loss function, the total loss function is determined based on the first to third coefficients, and the first to third coefficients are real numbers of 0 or more, respectively.

18. The operation method according to claim 12, wherein the transformation operation included in the latent space correction operation is determined to include at least one of a transition transformation operation, a rotation transformation operation, or a scaling transformation operation for the latent data output from the second encoder within a second latent space corresponding to an output end of the second encoder.

19. The operation method according to claim 12, wherein the transmitting of the information related to the reference data set comprises:
configuring information related to a first latent data set generated by encoding the reference data set through a first encoder of the first artificial neural network; and
transmitting, to the second communication node, information of the reference data set and the information related to the first latent data set,
wherein the latent space correction operation is determined based on a relationship between a second latent data set generated by encoding the reference data set through the second encoder and the first latent data set.

20. The operation method according to claim 19, wherein the configuring of the information related to the first latent data set comprises:
identifying positions of one or more data elements constituting the first latent data set on a first latent space corresponding to an output end of a first encoder of the first artificial neural network;
calculating an average of the positions and identifying a centroid of the positions;
correcting the first latent data set so that the identified centroid becomes an origin of the first latent space; and
configuring the information related to the first latent data set to include information on the corrected first latent data set.
